(19) United States
(12) Patent Application Publication
(10) Pub. No.: US 2005/0053036 A1
(43) Pub. Date: Mar. 10, 2005

(54) Multi-carrier communication system, multi-carrier receiver apparatus and multi-carrier transmitter apparatus

(76) Inventor: Daisuke Takeda, Tokyo (JP)

Correspondence Address: Finnegan, Henderson, Farabow,;Garrett & Dunner, L.L.P., 1300 I Street, N.W., Washington, DC, 20005-3315, US

(21) Appl. No.: 10/895,333

(22) Filed: Jul. 21, 2004

(30) Foreign Application Priority Data
Jul. 28, 2003 (JP) P2003-202555

(51) Int. Cl. H04Q 7/00

(52) U.S. Cl. 370/332

(57) ABSTRACT

Transmission/reception power can be controlled properly. At a radio apparatus, SIR measuring sections measure individual SIRs of sub-carriers included in a multi-carrier signal received at radio apparatus. A first command generating section generates a first command representative of whether to increase, to decrease or maintain as it is the individual power for decreasing a variation of individual SIRs. A second command generating section calculates a total SIR and generates a second command for matching the total SIR to a reference value. At a transmitter apparatus, under control of a individual-power control section, gain control section controls individual powers according to the first command while maintaining at constant the total power of the multi-carrier signal to be sent. Under control of a total-power control section, an amplifier controls the total power of the multi-carrier signal according to the second command.

### BACKGROUND OF THE INVENTION

1. Field of the Invention

The present invention relates to a multi-carrier communication system, multi-carrier receiver apparatus and multi-carrier transmitter apparatus for wirelessly sending a multi-carrier signal using a multiplicity of sub-carriers.

2. Description of the Related Art

There is known a technology for improving the performance also in respect of frequency-selective fading by carrying out transmission power control on a carrier-by-carrier basis, as an art concerning transmission power control in multi-carrier communications utilizing OFDM (Orthogonal Frequency Division Multiplex).

It is known that a combination of power control of the sub-carriers of a multi-carrier and power control of the entire multi-carrier modulated is used in multi-carrier communication system. This approach is disclosed in Japanese laid open (Kokai) JP-A-5-268178. This approach improves the performance, as to frequency-selective fading by sub-carrier-based transmission power control and as to flat fading by the entire control of transmission power.

However, when any carrier goes below a target value in its reception level at the receiving station, the transmitting station increases the modulation output level only on the relevant carrier.

In the meanwhile, even where a particular carrier is dropped in power due to frequency-selective fading, the required performance of communication is possibly satisfied by error corrections or so in case the multi-carrier signal has a reception level entirely exceeding a target value. In such a situation, when the lowered carrier power only is put under control at the transmitting station, the receiving station is to receive power excessively. Namely, transmission power becomes excessive at the transmitting station, resulting in a fear to cause unnecessarily cell capacitance decrease and to increase interference with other stations.

The present invention has been made in view of such a circumstance, and it is an object thereof to provide a multi-carrier communication system, multi-carrier receiver apparatus and multi-carrier transmitter apparatus which can control transmission/reception power properly.

### SUMMARY OF THE INVENTION

In order to achieve the above object, the present invention provides a multi-carrier transmission system having a transmitter for sending a multi-carrier signal including a plurality of sub-carrier signals and a receiver for receiving the multi-carrier signal, the receiver comprising: measuring unit configured to measure a total quality value of a multi-carrier signal received and individual quality values of sub-carrier signals included in the multi-carrier signal; first control information generating unit configure to generate first control information so as to reduce a variation of the individual quality values, for each of the sub-carrier signal; second control information generating unit configure to generate second control information so as to match the total quality value to a reference value; and notifying unit configure to notify the first control information and second control information to the transmitter; the transmitter comprising: individual power control unit configure to control individual powers of the sub-carrier signals included in the multi-carrier signal to be sent according to the first control information, while maintaining at constant a total power of the multi-carrier signal to be sent; and total power control unit configure to control the total power of the multi-carrier signal to be sent, according to the second control information.

The receiver measures a total quality value of a multi-carrier signal received and individual quality values of sub-carrier signals. Generated are first control information to reduce a variation of individual quality values on each sub-carrier signal and second control information for matching the total quality value to a reference value. The first control information and second control information are notified from the receiver to the transmitter. The transmitter controls the individual power of sub-carrier signals included in the multi-carrier signal to be sent according to the first control information, and the total power of the multi-carrier signal to be sent according to the second control information while maintaining at constant the total power of the multi-carrier signal to be sent. Accordingly, in the transmitter, individual powers are controlled in a manner reducing a variation of individual quality values while maintaining the total power at constant whereby the total power is controlled in a manner matching the total quality value to a reference value.

### BRIEF DESCRIPTION OF THE DRAWINGS

FIG. 1 is a block diagram of a multi-carrier communication system according to a first embodiment;

FIGS. 2A to 2E are figures showing a flow of power control in the multi-carrier communication system of the first embodiment;

FIG. 3 is a figure showing an example of channel configuration in the case of sending a multi-carrier signal from radio apparatus 1 to radio apparatus 2 through a radio channel;

FIG. 4 is a block diagram of a multi-carrier communication system according to a second embodiment;

FIGS. 5A to 5E are figures showing a flow of power control in the multi-carrier communication system of the second embodiment.

### DETAILED DESCRIPTION OF THE INVENTION

Now, embodiments of the present invention are explained while referring to the drawings.

(First Embodiment)

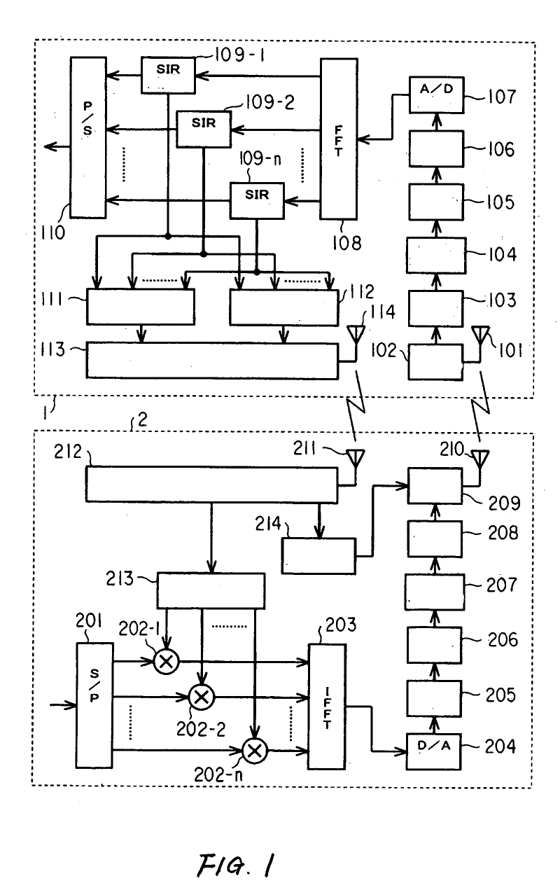

FIG. 1 is a block diagram of a multi-carrier communication system according to a first embodiment.

The multi-carrier communication system shown in FIG. 1 includes two radio apparatuses 1, 2, to wirelessly send a multi-carrier signal from the radio apparatus 2 to the radio apparatus 1.

The radio apparatus 1 includes a reception antenna 101, an amplifier 102, a filter 103, a down-converter 104. a filter 105, an amplifier 106, an A/D converter 107, a high-speed Fourier transformer (hereinafter, referred to as FFT) 108, SIR measuring sections 109-1, 109-2 . . . 109-n, a P/S converter 110, a first command generating section 111, a second command generating section 112, a transmitter system 113 and a transmission antenna 114.

The multi-carrier signal radiated as a radio wave from the radio apparatus 2 is converted into an electric signal by the reception antenna 101 and inputted to the amplifier 102. The amplifier 102 amplifies the input signal in a manner compensating for a loss due to radio transmission, and then outputs it to the filter 103. The filter 103 extracts only a desired radio frequency band component from the input signal and outputs the extracted signal to the down-converter 104. The down-converter 104 down-converts the input signal from a radio frequency band into a base band and outputs a base-band signal to the filter 105. The filter 105 removes an unwanted frequency component from the input signal and then outputs it to the amplifier 106. The amplifier 106 adjusts the input signal level to a level suited for a dynamic range of the A/D converter 107 and outputs it to the A/D converter 107. The A/D converter 107 digitizes the input signal and outputs it to the FFT 108.

The FFT 108 carries out a high-speed Fourier transform on the input signal and separates the information in a series of n sent on sub-carriers in the number of n mapped in frequency, thus outputting the information in a series of n to the respective SIR measuring sections 109-1, 109-2 . . . , 109-n. The SIR measuring sections 109-1, 109-2 . . . , 109-n output the input signals directly to the P/S converter 110. The SIR measuring sections 109-1, 109-2, . . . , 109-n each measure an SIR (signal-to-interference-power ratio) of each sub-carrier, on the basis of the input signal. The SIR measuring section 109-1, 109-2, . . . , 109-n outputs a measured SIR (hereinafter, referred to as individual SIR) to the first command generating section 111 and second command generating section 112. The P/S converter 110 makes the parallel input signals of from the SIR measuring sections 109-1, 109-2, . . . , 109-n into a serial one. Thus, an OFDM demodulator is configured by the FFT 108 and the P/S converter 110. Incidentally, SIR is one of the values representative of a quality of a multi-carrier signal received.

The first command generating section 111 generates a first command representative of an increase/decrease of sub-channel-based individual transmission powers (hereinafter, referred to as individual powers, which is the individual power of sub-carrier), depending upon the individual SIRs inputted. The first command generating section 111 outputs a generated first command to the transmitter system 113. The second command generating section 112 calculates an SIR over the entire of the received multi-carrier signal (hereinafter, referred to as the total SIR) depending upon the individual SIRS. The second command generating section 112 generates a second command representative of an increase or decrease in transmission power in the entire of the multi-carrier signal (hereinafter, referred to as the total power) depending upon the total SIR. The second command generating section 112 outputs a generated second command to the transmitter system 113.

The transmitter system 113 carries out a signal processing for wirelessly sending information from the radio apparatus 1 to the radio apparatus 2. The transmitter system 113 maps the first and second commands onto a series of bits for transmission. The transmission antenna 114 emits the output signal of the transmitter system 113 into the space.

The radio apparatus 2 includes an S/P converter 201, gain control sections 202-1, 202-2, . . . , 202-n, an inverse high-speed Fourier converter (hereinafter, referred to as IFFT) 203, a D/A converter 204, an amplifier 205, a filter 206, an up-converter 207, a filter 208, an amplifier 209, a transmission antenna 210, a reception antenna 211, a receiver system 212, a individual-power control section 213 and a total-power control section 214.

The S/P converter 201 separates the serial-inputted transmitting data into signals in the number (n) equal to the number of sub-carriers, and outputs these signals to the gain control sections 202-1, 202-2, . . . , 202-n, respectively. The gain control section 202-1, 202-2, . . . , 202-n processes the input signal in a manner adjusting a individual power under control of the individual power control section 213, and then outputs it to the IFFT 203. The IFFT 203 carries out an inverse high-speed Fourier transform on the input signals in the number of n, thereby generating one multi-carrier signal. The IFFT 203 outputs a generated signal to the D/A converter 204. Thus, an OFDM modulator is configured by the S/P converter 201 and the IFFT 203.

The D/A converter 204 makes the input signal into an analog one and outputs it to the amplifier 205. The amplifier 205 amplifies the input signal and outputs it to the filter 206. The filter 206 removes unwanted frequency components from the input signal and outputs it to the up-converter 207. The up-converter 207 up-converts the input signal from a base band to a radio frequency band and outputs a radio-frequency band signal to the filter 208. The filter 208 extracts only a component of within a frequency band permitted for use from the input signal, and outputs the extracted signal to the amplifier 209. The amplifier 209 amplifies the input signal up to a power level for radio transmission and outputs it to the transmission antenna 210. The amplifier 209 can change the gain under control of the total-power control section 214. The transmission antenna 210 emits a radio wave in accordance with the input signal.

The reception antenna 211 receives a radio wave radiated from the transmission antenna 114 of the radio apparatus 1 and converts it into an electric signal, and outputs the signal to the receiver system 212. The receiver system 212 carries out a signal processing for extracting various pieces of information from the input signal. The receiver system 212 outputs the first command to the individual-power control section 213 and the second command to the total-power control section 214, respectively. The individual-power control section 213 controls the gain control sections 202-1, 202-2 . . . , 202-n in order to adjust the individual powers, depending upon the first command. The total-power control section 214 controls the gain of the amplifier 209 in order to adjust the total power, depending upon the second command.

Now, explanation is made on the operation of the multi-carrier communication system in the first embodiment configured as above.

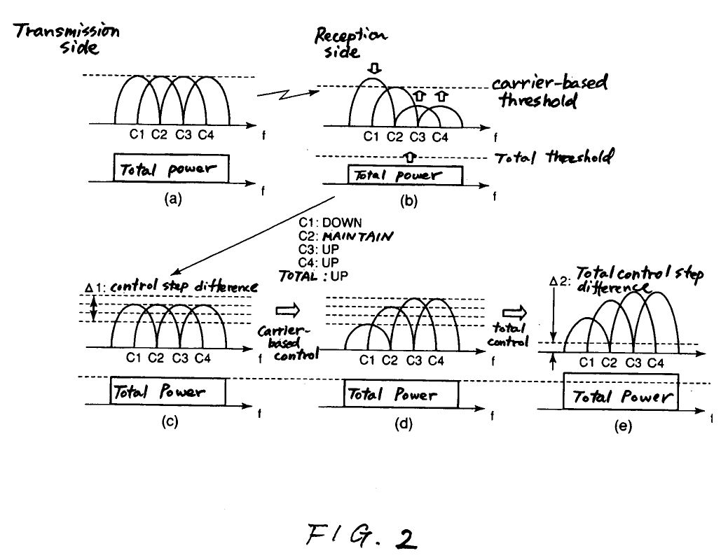

It is assumed that, when the radio apparatus 2 sends a multi-carrier signal having a individual power and total power in a state shown in FIG. 2A, the multi-carrier signal received at the radio apparatus 1 has a individual power and total power changed as in FIG. 2B due to frequency-selective fading. Incidentally, although there are actually a greater number of sub-carriers, here is shown an example using four sub-carriers C1, C2, C3, C4 in order for simplifying explanation.

In this case, the sub-carriers C1, C2, C3, C4 are respectively measured for SIR by the SIR measuring sections 109-1, 109-2 . . . , 109-n. The measured individual SIRs are provided to the first command generation section 111 and the second command generating section 112.

The first command generating section 111 compares each individual SIR with a carrier-based threshold and determines, for each sub-carrier, whether to increase (UP), to decrease (DOWN) or to maintain as it is the individual power according to a comparison result, as follows:

if individual SIR>carrier-based threshold, then DOWN,

if individual SIR=carrier-based threshold, then maintain as it is, and

if individual SIR<carrier-based threshold, then UP.

Then, the first command generating section 111 generates a first command representative of the determination result, for each of the sub-carriers. In the example shown in FIG. 2B, the first command generating section 111 generates a first command representative of “DOWN” for a sub-carrier C1, “maintain as it is” for a sub-carrier C2, “UP” for a sub-carrier C3 and “UP” for a sub-carrier C4.

The second command generating section 112 calculates a total SIR as a mean value over all the individual SIRs. The second command generating section 112 compares the calculated total SIR with a total threshold, and determines whether to increase (UP), to decrease (DOWN) or to maintain as it is the total power depending upon a comparison result, as follows:

if total SIR>total threshold, then DOWN,

if total SIR=total threshold, then maintain as it is, and if total SIR<total threshold, then UP.

Thus, the second command generating section 112 generates a second command representative of a determination result. In the example shown in FIG. 2B, the second command generating section 112 generates a second command representative of “UP”.

Incidentally, the carrier-based threshold and the total threshold are previously set as design values, for example.

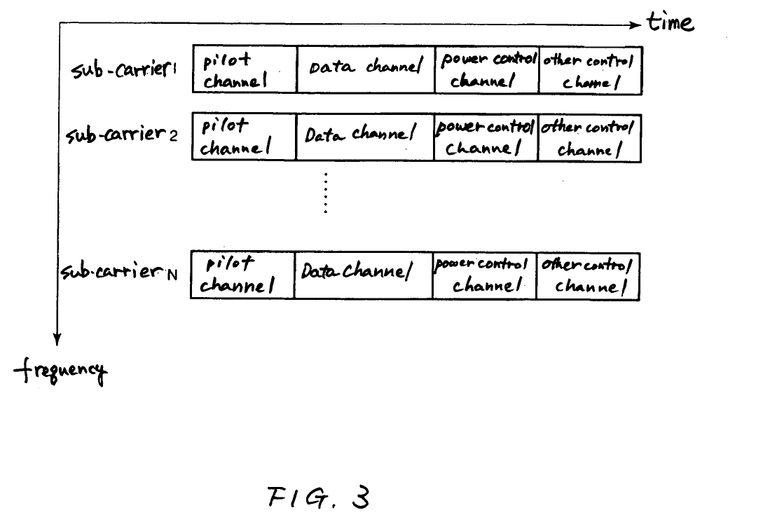

FIG. 3 shows an example of a channel configuration with radio channels in the case to send a multi-carrier signal from the radio apparatus 1 to the radio apparatus 2 through radio channels.

As shown in FIG. 3, the sub-carrier is mapped with a pilot symbol for allowing the receiver system to measure a carrier power. Meanwhile, power control channels are assigned to all the sub-carriers in order to satisfy quick response. In order to provide the multi-carrier signal with such a channel configuration, the transmitter system 113 makes a mapping of a first command to the power control channels respectively assigned to the corresponding sub-carriers and of a second command to all the power control channels.

In this manner, the first and second commands are conveyed from the radio apparatus 1 to the radio apparatus 2. In the radio apparatus 2, the receiver system 212 extracts the first and second commands. In the radio apparatus 2, the individual power control section 213 and the total power control section 214 carry out control of individual and total power control, on the basis of the extracted first command and second command.

At first, the individual-power control section 213 confirms the first command in its entire content and determines the total number of sub-carriers to decrease the individual power, the total number of sub-carriers to increase the individual power, and the total number of sub-carriers not to increase nor decrease the individual power. The individual-power control section 213 calculates, by the following equation, an increment Δ+ of the individual power “UP” is designated by the first command and a decrement Δ− of the individual power “DOWN” is designated.
Δ+=Δ1×(total number of sub-carriers to decrease the individual power)/(total number of carriers−total number of sub-carriers not to increase nor decrease the individual power)
Δ−=Δ1×(total number of sub-carriers to increase the individual power)/(total number of carriers−total number of sub-carriers not to increase nor decrease the individual power)

However, in the case that all the first commands represent “UP” or “DOWN”, the individual-power control section 213 renders Δ+ and Δ− both “0”.

Here, Δ1 is a power-control step difference of from sub-carrier to sub-carrier. Namely, Δ1 is the maximum amount for increasing or decreasing the individual power at one time. Accordingly, as Δ1 is taken greater, the power to be increased or decreased per time becomes greater. The concrete value of Δ1 is set during design while taking into account various conditions of the system or the radio apparatus 2.

Then, the individual-power control section 213 controls the respective gains of the gain control sections 202-1, 202-2 . . . , 202-n such that the sub-carrier designated “UP” on the first command is increased in its individual power by an amount Δ+ while the sub-carrier designated “DOWN” is decreased in its individual power by an amount Δ−.

In the FIG. 2 example, the total number of sub-carriers to decrease the individual power is given “1”, the total number of sub-carriers to increase the individual power is given “2”, and the total number of sub-carriers not to increase/decrease the individual power is given “1”. Consequently, the increment Δ+ and the decrement Δ− is to be determined as follows:
Δ+=Δ1×1/(4−1)=Δ1×⅓
Δ−=Δ1×2/(4−1)=Δ1×⅔

Consequently, the individual-power control section 213 increases by an amount Δ1×⅓ the individual powers of the sub-carriers C3, C4 designated “UP” on the first command, and decreases by an amount Δ1×⅔ the individual power of the sub-carrier C1 designated “DOWN”. As a result, the transmission power assumed the state shown in FIG. 2C is changed to the state shown in FIG. 2D. Namely, the individual powers are changed in a manner decreasing a variation of the individual SIRs shown in FIG. 2B. At this time, because the two individual powers are each increased by an amount Δ1×⅓ and one individual power is decreased by an amount Δ1×⅔, the total increment and decrement of the individual powers are both Δ1×⅔, thus maintaining the total power at constant.

In this manner, the information of the sub-carriers adjusted in individual power is mapped in frequency by the IFFT 20, to generate a multi-carrier signal. The multi-carrier signal is processed sequentially by the D/A converter 204, the amplifier 205, the filter 206, the up-converter 207 and the filter 208, thereafter being inputted to the amplifier 209 where it is amplified.

In the meanwhile, the gain of the amplifier 209 is controlled by the total-power control section 214, on the basis of the second command. The total-power control section 214, when “UP” is designated by the second command, raises the gain of the amplifier 209 in a manner increasing the total power by an amount Δ2. In case “DOWN” is designated, it decreases the gain of the amplifier 209 in a manner decreasing the total power by an amount Δ2. When “maintain as it is” is designated, it does not change the gain of the amplifier 209.

Here, Δ2 is a power-control step difference of from sub-carrier to sub-carrier. Namely, Δ2 is a step difference at which the total power is to be increased or decreased at one time. The concrete value of Δ2 is set during design while taking into account various conditions of the system or the radio apparatus 2. In the FIG. 2 example, because “UP” is designated by the second command, the total power is increased by an amount Δ2 with respect to the former as shown in FIG. 2E.

Thus, according to the first embodiment, in the radio apparatus 1, the received multi-carrier signal is measured for individual SIRs by the SIR measuring sections 109-1, 109-2 . . . , 109-n. Meanwhile, the received multi-carrier signal is measured for its total SIR on the basis of these individual SIRs. The first command generating section 111 generates a first command representative of a result of determination of whether to increase, to decrease or to maintain as it is the individual power of the sub-carrier on the basis of the above individual SIR, as information to reduce a variation of between the individual SIRs. Meanwhile, the second command generating section 112 generates a second command representative of whether to increase, to decrease or to maintain as it is the total power of the multi-carrier signal, as information to match the total SIR to a reference value. The first and second commands are sent to the radio apparatus 2 by the transmitter system 113.

In the radio apparatus 2, the individual-power control section 213 calculates an increment and decrement of the individual power on the basis of the first command. The respective gains of the gain control sections 202-1, 202-2 . . . , 202-n are controlled to increase or decrease the individual powers by that increment or decrement. Due to this, in the gain control sections 202-1, 202-2 . . . , 202-n, the individual powers of the sub-carriers are adjusted to reduce a variation of between the individual SIRs while maintaining the total power at constant. Furthermore, the total-power control section 214 controls to increase, decrease or maintain as it is the gain of the amplifier 209 by a constant step difference Δ2 on the basis of the second command. Due to this, the total power of the multi-carrier signal is adjusted by the amplifier 209.

According to the first embodiment, when adjusting the individual powers by the gain control sections 202-1, 202-2 . . . , 202-n, there is no change caused in the total power, i.e. the total power is adjusted only by the amplifier 209. There is less possibility of excessively increasing the total power under the power control for reducing the variation of between the individual SIRs, thus enabling to effect proper power control. As a result, it is possible to prevent cell capacitance lowering and interference increase with other stations, enabling to maintain the quality of communications favorable.

Meanwhile, in the multi-carrier communication system in the first embodiment, the first and second commands for power control to be sent from the radio apparatus 1 to the power apparatus 2 satisfactorily represent whether to increase, to decrease or to maintain as it is the individual powers and the total power. Accordingly, the first and second commands satisfactorily require data small in size.

(Second Embodiment)

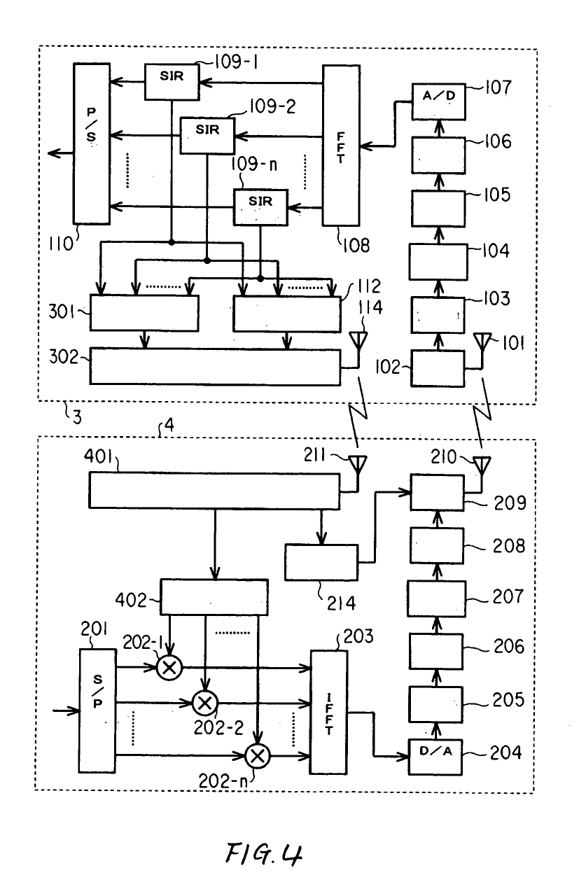

FIG. 4 is a block diagram of a multi-carrier communication system according to a second embodiment. Incidentally, the elements like those of FIG. 1 are attached with like references, to omit the detailed explanation thereof.

The multi-carrier communication system shown in FIG. 4 includes two radio apparatuses 3, 4, to wirelessly send a multi-carrier signal from the radio apparatus 4 to the radio apparatus 3.

The radio apparatus 3 includes a reception antenna 101, an amplifier 102, a filter 103, a down-converter 104. a filter 105, an amplifier 106, an A/D converter 107, an FFT 108, SIR measuring sections 109-1, 109-2 . . . 109-n, a P/S converter 110, a second command generating section 112, a transmission antenna 114, an SIR information generating section 301 and a transmitter system 302. Namely, the radio apparatus 3 has the SIR information generating section 301 and transmitter system 302 in place of the first command generating section 111 and transmitter section 113.

The SIR information generating section 301 is inputted by individual SIRs respectively measured by the SIR measuring sections 109-1, 109-2 . . . , 109-n. The SIR information generating section 301 generates SIR information representative of individual SIRs and outputs the SIR information to the transmitter system 302. The transmitter system 302 carries out a signal processing for wirelessly sending information from the radio apparatus 3 to the radio apparatus 4. The transmitter system 302 makes a mapping of the SIR information and second command onto a series of bits for transmission.

The radio apparatus 4 includes an S/P converter 201, gain control sections 202-1, 202-2, . . . , 202-n, an IFFT 203, a D/A converter 204, an amplifier 205, a filter 206, an up-converter 207, a filter 208, an amplifier 209, a transmission antenna 210, a reception antenna 211, a total-power control section 214, a receiver system 401 and a individual-power control section 402. Namely, the radio apparatus 4 has the receiver system 401 and individual-power control section 402 in place of the receiver system 212 and individual-power control section 213 of the radio apparatus 2.

The receiver system 401 makes a signal processing to extract various pieces of information from the input signal. The receiver system 401 outputs a second command to the total-power control section 214 and SIR information to the individual-power control section 402, respectively. The individual-power control section 402 controls the gain control sections 202-1, 202-2 . . . , 202-n in order to adjust the individual powers on the basis of the individual SIRs represented by the SIR information.

Now, explanation is made on the operation of the multi-carrier communication system in the second embodiment configured as above.

The power control in the multi-carrier communication system of the second embodiment is carried out in a flow similar to that of the first embodiment. However, sharing the power control process by the radio apparatuses is different between the embodiments. In the following, explanation is made centering on the different operation.

The radio apparatus 3 does not generate a first command. Instead, the SIR information generating section 301 generates SIR information directly representative of individual SIRs. Then, the transmitter system 302 sends the SIR information, in place of a first command to the radio apparatus 4.

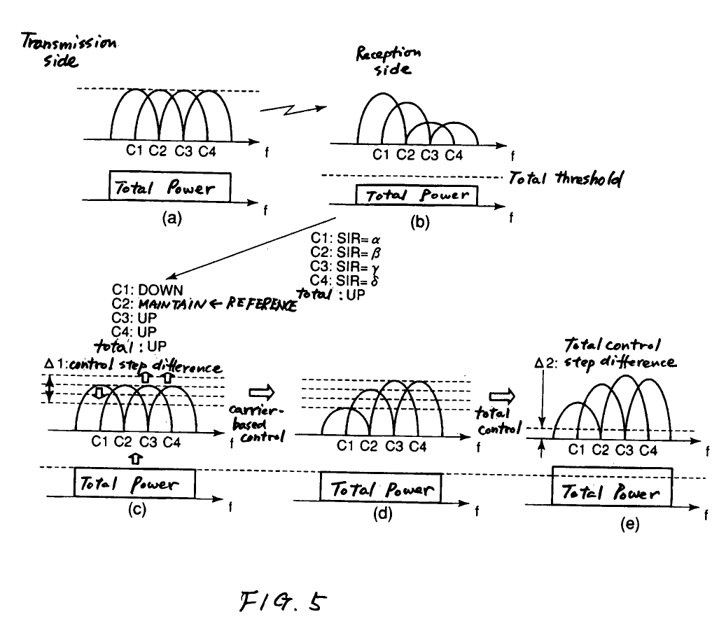

Thus, the radio apparatus 4 is notified of individual SIR values α, β, γ, δ, as they are, measured from the multi-carrier signal varied in individual power and total power by frequency-selective fading as shown in FIG. 5B.

In the radio apparatus 4, the receiver system 401 extracts the SIR information and outputs it to the individual-power control section 402. The individual-power control section 402 compares each individual SIR with a carrier-based threshold and determines as to whether to increase (UP), to decrease (DOWN) or to maintain as it is the individual power on each sub-carrier according to a comparison result, as follows:
when individual SIR>carrier-based threshold, then DOWN,
when individual SIR=carrier-based threshold, then maintain as it is, and
when individual SIR <carrier-based threshold, then UP.

In the case of an example shown in FIG. 5C, the individual-power control section 402 determines “DOWN” for a sub-carrier C1, maintaining as it is for a sub-carrier C2, “UP” for a sub-carrier C3 and “UP” for a sub-carrier C4.

Subsequently, the individual-power control section 402 determines the number of sub-carriers to decrease the individual power, the number of sub-carriers to increase the individual power, and the number of sub-carriers not to increase nor decrease the individual power. The individual-power control section 402 calculates an increment Δ+ of the individual power determined as “UP” and a decrement Δ− of the individual power determined as “DOWN” by the following equation.
Δ+=Δ1×(total number of sub-carriers to decrease the individual power)/(total number of carriers−total number of sub-carriers not to increase nor decrease the individual power)
Δ−=Δ1×(total number of sub-carriers to increase individual power)/(total number of carriers−total number of sub-carriers not to increase nor decrease the individual power)

However, in the case that all the first commands represent “UP” or “DOWN”, the individual-power control section 402 renders Δ+ and Δ− both “0”.

Then, the individual-power control section 402 controls the respective gains of the gain control sections 202-1, 202-2 . . . , 202-n such that the sub-carrier designated “UP” is increased in its individual power by an amount Δ+ while the sub-carrier designated “DOWN” is decreased in its individual power by an amount Δ−.

Thus, according to the second embodiment, in the radio apparatus 3, the individual SIRs of a received multi-carrier signal are measured by the SIR measuring sections 109-1, 109-2 . . . , 109-n. Meanwhile, on the basis of the individual SIRs, the received multi-carrier signal is measured for its total SIR, to generate SIR information representative of the individual SIRs. Meanwhile, the second command generating section 112 generates a second command representative of whether to increase, to decrease or to maintain as it is the total power of the multi-carrier signal, as information to match the total SIR to a reference value. The SIR information and the second command are sent by the transmitter system 302 to the radio apparatus 4.

In the radio apparatus 4, the individual-power control section 402 determines based on the individual SIR represented by the SIR information whether to increase, to decrease or to maintain as it is the individual power, and further calculates an increment/decrement of the individual power depending upon a determination result. Then, the individual-power control section 402 controls the respective gains of the gain control sections 202-1, 202-2 . . . , 202-n to increase/decrease the individual power by an amount of the increment/decrement. Due to this, in the gain control sections 202-1, 202-2 . . . , 202-n, the individual powers of the sub-carriers are adjusted to maintain the total power at constant and decrease a variations of the individual SIRs. Furthermore, the total-power control section 403 controls to increase or decrease the gain of the amplifier 209 by a constant step difference Δ2 or to maintain it as it is, on the basis of the second command. Due to this, the amplifier 209 adjusts the total power of the multi-carrier signal.

Therefore, according to the second embodiment, when adjusting the individual powers by the gain control sections 202-1, 202-2 . . . , 202-n, the total power is not caused a change but adjusted only by the amplifier 209. There is no possibility of excessively increasing the total power under the power control for reducing a variation of the individual SIRs, thus enabling to effect proper power control. As a result, it is possible to prevent cell capacitance lowering and interference increase with other stations, enabling to maintain the quality of communications favorable.

Meanwhile, in the multi-carrier communication system of the second embodiment, because the determination of whether to increase, to decrease or to maintain as it is the individual power is effected not by the radio apparatus 3 but by the radio apparatus 4, the radio apparatus 3 is relieved of load. For example, in case the multi-carrier communication system of the second embodiment is applied to a mobile communication system while the radio apparatus 3 is mounted on a base station and the radio apparatus 4 on a mobile station, the determination of whether to increase, to decrease or to maintain as it is the individual power can be effected separately at mobile stations with efficiency.

The foregoing embodiment can be modified in various ways, as follows.

The foregoing embodiment may determine a difference of between a individual SIR and a carrier-based threshold on a sub-carrier-by-sub-carrier basis, to take this difference as a correction amount to the individual power. By doing so, the individual power can be adjusted in a manner compensating for even a slight difference in the individual SIR, making it possible to implement favorable communications.

In the foregoing embodiment, the scheme of multi-carrier modulation is not limited to OFDM.

In the foregoing embodiment, other quality values, e.g. reception electric-field intensity, may be employed in place of SIR.

In the first embodiment, an increment Δ+ and decrement Δ− may be calculated by the radio apparatus 1 so that it can be notified together with the first command to the radio apparatus 2.

Incidentally, the present invention is not directly limited to the foregoing embodiment but, in practical application stage, can be embodied with modifications to the constituent elements within a scope not departing from the gist thereof. Meanwhile, various inventions are to be constituted by a proper combination of a plurality of constituent elements disclosed in the foregoing embodiment. For example, some constituent elements may be omitted of all the constituent elements shown in the embodiment. Furthermore, a suitable combination may be possible of those in the different embodiments.

The transmission-sided individual power control for reducing the receiver-sided variation in individual quality value is effected while maintaining the total power at constant. Thereafter, the total-power control for matching the total quality value at the total-SIR reception side to a reference value is carried out at the transmission side. Thus, transmission/reception power can be controlled properly.

1. A multi-carrier transmission system having a transmitter for sending a multi-carrier signal including a plurality of sub-carrier signals and a receiver for receiving the multi-carrier signal,
the receiver comprising:
measuring unit configured to measure a total quality value of a multi-carrier signal received and individual quality values of sub-carrier signals included in the multi-carrier signal;
first control information generating unit configure to generate first control information so as to reduce a variation of the individual quality values, for each of the sub-carrier signal;
second control information generating unit configure to generate second control information so as to match the total quality value to a reference value; and
notifying unit configure to notify the first control information and second control information to the transmitter;
the transmitter comprising:
individual power control unit configure to control individual powers of the sub-carrier signals included in the multi-carrier signal to be sent according to the first control information, while maintaining at constant a total power of the multi-carrier signal to be sent; and
total power control unit configure to control the total power of the multi-carrier signal to be sent, according to the second control information.

2. A multi-carrier communication system according to claim 1, wherein the first control information generating unit determines any of to increase, to decrease and to maintain as it is a individual power of each of the sub-carrier signals depending upon a magnitude of a individual quality value and a threshold, and generates first control information representative of a determination content thereof, wherein the individual power control unit further comprises
first individual power calculating unit configure to calculate an increment of the individual power by multiplying by a constant value a percentage of sub-carriers to increase the individual power of among sub-carriers to increase or decrease the individual power, on the basis of the first control information;
second individual power calculating unit configure to calculate a decrement of the individual power by multiplying by the constant value a percentage of sub-carriers to decrease the individual power of among sub-carriers to increase or decrease the individual power, on the basis of the first control information; and
power adjusting unit configure to increase by the increment the individual power of sub-carrier represented to increase the individual power by the first control information and to decrease by the decrement the individual power of sub-carrier represented to decrease the individual power by the first control information.

3. A multi-carrier receiver for receiving from a multi-carrier transmitter a multi-carrier signal including a plurality of sub-carrier signals, the receiver comprising:
measuring unit configure to measure a total quality value of a multi-carrier signal received and individual quality values of sub-carrier signals included in the multi-carrier signal;
first control information generating unit configure to generate first control information so as to decrease a variation of the individual quality values, on each sub-carrier signal;
second control information generating unit configure to generate second control information so as to match the total quality value to a reference value; and
sending unit configure to send the first control information and second control information to the transmitter.

4. A multi-carrier receiver according to claim 3, wherein the first control information generating unit determines any of to increase, to decrease and to maintain as it is the individual power of each of the sub-carrier signals depending upon a magnitude of each individual quality value and a threshold and generates the first control information representative of a determination content thereof.

5. A multi-carrier transmitter for transmitting to a multi-carrier receiver a multi-carrier signal including a plurality of sub-carrier signals, the transmitter comprising:
receiving unit configure to receive first control information and second control information sent from the multi-carrier receiver;
individual power control unit configure to control the individual power of each of the sub-carrier signals included in the multi-carrier signal according to the first control information received while maintaining at constant a total power of the multi-carrier signal; and
total power control unit configure to control the total power of the multi-carrier signal according to the second control information received.

6. A multi-carrier transmitter according to claim 5, wherein the individual power control unit further comprises
first individual power calculating unit configure to calculate an increment of the individual power by multiplying by a constant value a percentage of sub-carriers to increase the individual power of among sub-carriers to increase or decrease the individual power, on the basis of the first control information;
second individual power calculating unit configure to calculate a decrement of the individual power by multiplying by a constant value a percentage of sub-carriers to decrease the individual power of among sub-carriers to increase or decrease the individual power, on the basis of the first control information; and
power adjusting unit configure to increase by the increment the individual power of sub-carrier represented to increase the individual power by the first control information and to decrease by the decrement the individual power of sub-carrier represented to decrease the individual power by the first control information.

7. A multi-carrier communication system having a transmitter for sending a multi-carrier signal including a plurality of sub-carrier signals and a receiver for receiving the multi-carrier signal,
the receiver comprising:
measuring unit configure to measure a total quality value of the multi-carrier signal received and individual quality values of sub-carrier signals included in the multi-carrier signal; and
notifying unit configure to notify the transmitter of the total quality value and the individual quality values;
the transmitter comprising:
individual powers control unit configure to control individual powers of sub-carrier signals included in the multi-carrier signal to be sent, in a manner reducing a variation of the individual quality values while maintaining at constant a total power of the multi-carrier signal to be sent; and
total power control unit configure to control the total power of the multi-carrier signal to be sent, in a manner matching the total quality value to a reference value.

8. A multi-carrier receiver for receiving a multi-carrier signal including a plurality of sub-carrier signals from a multi-carrier transmitter, the receiver comprising:
measuring unit configure to measure a total quality value of a multi-carrier signal received and individual quality values of sub-carrier signals included in the multi-carrier signal; and
notifying unit configure to notify the total quality value and the individual quality values to the transmitter.

9. A multi-carrier receiver according to claim 8, wherein the measuring unit measures as the total quality value a power ratio of a multi-carrier signal received and an interference signal with the multi-carrier signal, and measures as the individual quality value a power ratio of each of sub-carrier signals included in the multi-carrier signal received and an interference signal with the sub-carrier signal.

10. A multi-carrier transmitter for sending a multi-carrier signal including a plurality of sub-carrier signals to a multi-carrier receiver, the transmitter comprising:
receiving unit configure to receive a notification of a total quality value and individual quality values from the multi-carrier receiver;
individual power control unit configure to control individual powers of sub-carrier signals included in the multi-carrier signal to be sent in a manner reducing a variation of the individual quality values while maintaining at constant a total power of the multi-carrier signal to be sent; and
total power control unit configure to control the total power of the multi-carrier signal to be sent in a manner matching the total quality value to a reference value.

11. A multi-carrier transmitter according to claim 10, wherein the individual power control unit comprises:
determining unit configure to determining any of to increase, to decrease and to maintain as it is the individual power of the sub-carrier signal, according to a magnitude of the individual quality value and a threshold;
first individual power calculating unit configure to calculate an increment of the individual power by multiplying by a constant value a percentage of sub-carriers to increase the individual power of sub-carriers determined to increase/decrease the individual power;
second individual power calculating unit configure to calculate a decrement of the individual power by multiplying by a constant value a percentage of sub-carriers to decrease the individual power of sub-carriers determined to increase/decrease the individual power; and
power adjusting unit configure to increase by the increment the individual power of sub-carriers determined to increase the individual power and to reduce by the decrement the individual power of sub-carriers determined to decrease the individual power.
